(19) United States
(12) Patent Application Publication
(10) Pub. No.: US 2019/0062671 A1
(43) Pub. Date: Feb. 28, 2019

(54) PERFUME COMPOSITIONS

(71) Applicant: Givaudan SA, Vernier (CH)

(72) Inventors: Andreas NATSCH, Uetikon (CH); Dominique LELIEVRE, Kindhausen (CH)

(21) Appl. No.: 16/078,448

(22) PCT Filed: Mar. 15, 2017
(86) PCT No.: PCT/EP2017/056068

§ 371 Date: Aug. 21, 2018

(30) Foreign Application Priority Data
Mar. 15, 2016 (GB) 1604372.1

(51) Int. Cl. C11B 9/00

(52) U.S. Cl. CPC C11B 9/0015; C11B 9/0061; C11B 9/0023; C11B 9/003

(57) ABSTRACT

A fragrance suitable as a substitute for Citral (3,7-dimethyl-2,6-octadienal) and fragranced products, essentially free of Citral but reminiscent of the odor and performance of Citral nevertheless.

Perfume Compositions

The present invention relates to fragrance suitable as a substitute for Citral (3,7-dimethyl-2,6-octadienal). The invention relates furthermore to perfume compositions and fragranced products, essentially free of Citral but possessing an odor and performance reminiscent of the odor and performance of Citral.

Citral is a compound which is used for its fresh, citrus, lemon, natural, juicy effect in perfumery, both fine and functional perfumery. Unfortunately, some people are allergic to Citral. When it became known that Citral was inducing skin allergies, IFRA (International Fragrance Association) recommended that it only be used in association with substances that prevent a sensitizing effect. It was believed for a long time that the skin sensitizing activity of Citral could be overcome by the presence of d-limonene and/or alpha-pinene (D. L. J. Opdyke, Food and Cosmetics Toxicology (1976), 14(3), 197-8), both of which are present in the essential oil in which Citral occurs naturally, for example, lemon grass oil, or citrus peel and leaf oils. Said process is known as “quenching”. However, it could never be scientifically demonstrated that “quenching” results in fragrance mixtures which are not skin sensitizing (David Basketter, Contact Dermatitis (2000), 43(5), 253-258.).

Thus, there remains a constant demand in the fragrance industry to provide compositions which are substantially free of Citral but having a similar olfactive contribution, mainly the naturalness, juiciness and freshness of Citral.

2,4,7-Trimethyl-2,6,-octadienal is described in the literature (U.S. Pat. No. 4,010,207) as possessing an excellent lemon citrus character useful for imparting lemon nuances to citrus-type perfume compositions and essential oils.

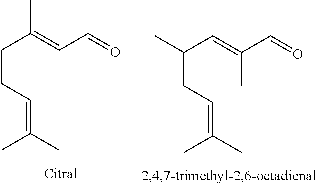

According to the generally-accepted, most advanced in silico model for the prediction of skin sensitizing potential of chemicals (TIMES SS model), both compounds, 2,4,7-trimethyl-2,6,-octadienal and Citral are predicted as strong sensitizers, based on their structure.

Inventors now found that 2,4,7-trimethyl-2,6,-octadienal possesses a significantly reduced skin sensitization potential, which is highly surprising, considering the close structural similarity to Citral (3,7-dimethyl-2,6-octadienal [(Z)-3,7-dimethylocta-2,6-dienal=Neral & (E)-3,7-dimethylocta-2,6-dienal=Geranial]) and considering the predictions on their skin sensitization potential made by computer models, namely the TIMES SS model, a computer model which predicts the sensitization potential based on all known structural features of skin sensitizers, and which is commonly used to predict the skin sensitization potential based on the chemical structure of molecules.

The level of skin sensitization can reliably and quantitatively be measured experimentally by the KeratinoSens® method, which measures the induction of Nrf2-dependent luciferase in a skin cell line. This test has been adopted as OECD test guideline 442d. While Citral has a strong activity in this assay, being positive at 7.7 μM, 2,4,7-trimethyl-2,6,-octadienal does not surpass the threshold for a positive rating up to the top dose.

Alternatively, the sensitization potential can be quantified by measuring the reactivity of test chemicals with peptides. This approach has been developed as the direct peptide reactivity assay (DPRA) and implemented in OECD test guideline 442c, whereby peptide reactivity is measured as depletion of test peptides in presence of chemicals. Modifications of the DPRA method which allow for a better quantification of reactivity have been described (A. Natsch, H. Gfeller, Toxicol. Sci. 2008, 106, 464-478). This modified test measures not only peptide depletion but also whether a chemical directly can modify a reactive peptide, which is the true hallmark of skin sensitization referred to as the molecular initiating event (MIE) (OECD. (2012) The Adverse Outcome Pathway for Skin Sensitisation Initiated by Covalent Binding to Proteins, Part 1: Scientific Evidence. OECD ENVIRONMENT, HEALTH AND SAFETY PUBLICATIONS, SERIES ON TESTING AND ASSESSMENT NO. 168). Based on this test, Citral does form a direct peptide adduct indicating its potential for protein modification. 2,4,7-Trimethyl-2,6,-octadienal has a reactivity which is 27 times lower than that of Citral in this assay.

The combined evidence from these different assays confirm that the skin sensitization potential of 2,4,7-trimethyl-2,6,-octadienal is strongly reduced, contrary to the results found by the computer models commonly used in industry to predict skin sensitization.

Thus, there is provided in a first aspect, a perfume composition comprising 2,4,7-trimethyl-2,6-octadienal, characterized in that the perfume composition is essentially free of Citral.

In a further embodiment there is provided a perfume composition essentially free of Citral, comprising 2,4,7-trimethyl-2,6-octadienal, characterized in that said perfume composition has a reduced skin sensitizing potential compared with an identical perfume composition in which 2,4,7-trimethyl-2,6-octadienal has been replaced by an equal weight of Citral.

The term “reduced sensitizing potential” as used herein means that the perfume formulation of the present invention comprising a certain level of 2,4,7-trimethyl-2,6-octadienal has a reduced risk of triggering allergies when used in consumer products as compared to a perfume composition comprising an equal weight of Citral.

Whereas 2,4,7-trimethyl-2,6,-octadienal taken alone possesses an odor profile which is close to that of Citral, perfumers found that it cannot be used alone as a direct replacement in fragrance formulations. Inventors found that 2,4,7-trimethyl-2,6,-octadienal is suitable as a substituent for Citral when 2,4,7-trimethyl-2,6,-octadienal is combined with at least one of the following compounds selected from the group (A) consisting of dihydro myrcenol (2,6-dimethyloct-7-en-2-ol), Methyl Pamplemousse™ (6,6-dimethoxy-2,5,5-trimethylhex-2-ene), Hedione® (methyl 3-oxo-2-pentylcyclopentaneacetate), ethyl linalool ((E)-3,7-dimethylnona-1,6-dien-3-ol), 3-(4-isobutyl-2-methylphenyl)propanal, and 2,4,7-trimethyloct-6-en-1-ol, or a mixture thereof. Surprisingly, in combination with the fragrance ingredients mentioned above, 2,4,7-trimethyl-2,6,-octadienal provides very similar performance and olfactive contribution compared to fragrance formulations comprising Citral.

Thus, there is provided in a further aspect, a perfume composition essentially free of Citral comprising
I) 2,4,7-trimethyl-2,6,-octadienal, and
II) at least one compound selected from the group (A) consisting of dihydro myrcenol (2,6-dimethyloct-7-en-2-131), Methyl Pamplemousse™ (6,6-dimethoxy-2,5,5-trimethylhex-2-ene), Hedione® (methyl 3-oxo-2-pentylcyclopentane-acetate), ethyl linalool ((E)-3,7-dimethylnona-1,6-dien-3-ol), 3-(4-isobutyl-2-methylphenyl)propanal, and 2,4,7-trimethyloct-6-en-1-ol, or mixtures thereof.

To achieve an even more natural, sometimes more citrus-like effect the perfume composition preferably comprises in addition at least one additional compound selected from the group (B) consisting of lemonile (3,7-dimethylnona-2,6-dienenitrile), citronellyl nitril (3,7-dimethyloct-6-enenitrile), citronellol, Rhubafuran™ (2,4-dimethyl-4-phenyltetrahydrofuran), and Precyclemone B (1-methyl-4-(4-methyl-3-pentenyl)-3-cyclohexene-1-carbaldehyde), or mixtures thereof.

Thus there is provided in a further aspect a perfume composition essentially free of Citral comprising
I) 2,4,7-trimethyl-2,6,-octadienal;
II) at least one compound selected from the group (A) consisting of dihydro myrcenol (2,6-dimethyloct-7-en-2-131), Methyl Pamplemousse™ (6,6-dimethoxy-2,5,5-trimethylhex-2-ene), Hedione® (methyl 3-oxo-2-pentylcyclopentane-acetate), ethyl linalool ((E)-3,7-dimethylnona-1,6-dien-3-ol), 3-(4-isobutyl-2-methylphenyl)propanal, and 2,4,7-trimethyloct-6-en-1-ol, or mixtures thereof; and
III) at least one compound elected from the group (B) consisting of lemonile (3,7-dimethylnona-2,6-dienenitrile), citronellyl nitryl (3,7-dimethyloct-6-enenitrile), citronellol, Rhubafuran™ (2,4-dimethyl-4-phenyltetrahydrofuran), and Precyclemone B (1-Methyl-4-(4-methyl-3-pentenyl)-3-cyclohexene-1-carbaldehyde), or mixtures thereof.

Perfume compositions as defined hereinabove result in formulations which are very similar with regard to freshness, naturalness and also providing citrus-like, lemon-like odor profile of Citral, with a reduced potential to trigger allergies.

Thus there is provided in a further embodiment a method for substituting Citral in a perfume composition comprising the step of admixing to a perfume composition, which is essentially free of Citral,
I) 2,4,7-trimethyl-2,6,-octadienal,
II) at least one compound selected from the group (A) consisting of dihydro myrcenol (2,6-dimethyloct-7-en-2-131), Methyl Pamplemousse™ (6,6-dimethoxy-2,5, 5-trimethylhex-2-ene), Hedione® (methyl 3-oxo-2-pentylcyclopentane-acetate), ethyl linalool ((E)-3,7-dimethylnona-1,6-dien-3-ol), 3-(4-isobutyl-2-methylphenyl)propanal, and 2,4,7-trimethyloct-6-en-1-ol, or mixtures thereof, and
III) optionally at least one compound selected from the group (B) consisting of lemonile (3,7-dimethylnona-2,6-dienenitrile), citronellyl nitryl (3,7-dimethyloct-6-enenitrile), citronellol, Rhubafuran™ (2,4-dimethyl-4-phenyltetrahydrofuran), and Precyclemone B (1-Methyl-4-(4-methyl-3-pentenyl)-3-cyclohexene-1-carbaldehyde), or mixtures thereof.

In a further aspect there is provided a fragranced product comprising a perfume composition comprising 2,4,7-trimethyl-2,6,-octadienal, and at least one compound selected from the group (A) consisting of dihydro myrcenol (2,6-dimethyloct-7-en-2-ol), Methyl Pamplemousse™ (6,6-dimethoxy-2,5,5-trimethylhex-2-ene), Hedione® (methyl 3-oxo-2-pentylcyclopentaneacetate), ethyl linalool ((E)-3,7-dimethylnona-1,6-dien-3-ol), 3-(4-isobutyl-2-methylphenyl)propanal, and 2,4,7-trimethyloct-6-en-1-ol, or mixtures thereof, and optionally at least one compound selected from the group (B) consisting of lemonile (3,7-dimethylnona-2,6-dienenitrile), citronellyl nitryl (3,7-dimethyloct-6-enenitrile), citronellol, Rhubafuran™ (2,4-dimethyl-4-phenyltetrahydrofuran), and Precyclemone B (1-Methyl-4-(4-methyl-3-pentenyl)-3-cyclohexene-1-carbaldehyde), or mixtures thereof, said perfume composition being essentially free of Citral.

Very similar effects compared to perfume compositions comprising Citral with regard to the odor profile and performance have been achieved with perfume compositions comprising 2,4,7-trimethyl-2,6,-octadienal and at least one compound selected from the group (A) consisting of dihydro myrcenol (2,6-dimethyloct-7-en-2-ol), Methyl Pamplemousse™ (6,6-dimethoxy-2,5,5-trimethylhex-2-ene), Hedione® (methyl 3-oxo-2-pentylcyclopentaneacetate), ethyl linalool ((E)-3,7-dimethylnona-1,6-dien-3-ol), 3-(4-isobutyl-2-methylphenyl)propanal, and 2,4,7-trimethyloct-6-en-1-ol, when admixed in a weight ratio of 1:3 to 1:10 or even higher (e.g., 1:15; 1:20;1:30; 1:40 or 1:50).

Thus, there is provided in another aspect a method of imparting freshness and naturalness to a fragranced product, said method comprising the step of incorporating into said product a perfume composition comprising 2,4,7-trimethyl-2,6,-octadienal, and at least one compound selected from the group (A) consisting of dihydro myrcenol (2,6-dimethyloct-7-en-2-ol), Methyl Pamplemousse™ (6,6-dimethoxy-2,5,5-trimethylhex-2-ene), Hedione® (methyl 3-oxo-2-pentylcyclopentaneacetate), ethyl linalool ((E)-3,7-dimethylnona-1,6-dien-3-ol), 3-(4-isobutyl-2-methylphenyl)propanal, and 2,4,7-trimethyloct-6-en-1-ol, in a weight ratio of 1:3 to 1:10 or even higher (e.g., 1:15; 1:20; 1:30; 1:40 or 1:50).

It is noted, that the order of admixing the individual ingredients of the fragrance mixture/perfume composition is not critical. Some of the ingredients may be pre-admixed, and then further admixed with the remaining components with techniques and methods known to the skilled person.

In addition to the ingredients mentioned above, the perfume composition may comprise further ingredients, including all known odorant ingredients selected from the extensive range of natural products and synthetic molecules currently available, such as essential oils, alcohols, aldehydes and ketones, ethers and acetals, esters and lactones, macrocycles and heterocycles, and/or in admixture with one or more ingredients or excipients conventionally used in conjunction with odorants in perfume compositions, for example, carrier materials, and other auxiliary agents commonly used in the art.

The following list comprises examples of known odorant ingredients, which may be present in the perfume composition:
essential oils and extracts, e.g. castoreum, costus root oil, oak moss absolute, geranium oil, tree moss absolute, basil oil, fruit oils, such as bergamot oil and mandarine oil, myrtle oil, palmarose oil, patchouli oil, petitgrain oil, jasmine oil, rose oil, sandalwood oil, wormwood oil, lavender oil and/or ylang-ylang oil;
alcohols, e.g. cinnamic alcohol ((E)-3-phenylprop-2-en-1-ol); cis-3-hexenol ((Z)-hex-3-en-1-01); Ebanol™ ((E)-3-methyl-5-(2,2,3-trimethylcyclopent-3-en-1-yl)pent-4-en-2-01); eugenol (4-allyl-2-methoxyphenol); farnesol ((2E,6Z)-3,7,11-trimethyldodeca-2,6,10-trien-1-ol); geraniol ((E)-3,7-dimethylocta-2,6-dien-1-ol); Super Muguet™ ((E)-6-ethyl-3-methyloct-6-en-1-ol); linalool (3,7-dimethylocta-1,6-dien-3-ol); menthol (2-isopropyl-5-methylcyclohexanol); Nerol (3,7-dimethyl-2,6-octadien-1-01); phenyl ethyl alcohol (2-phenylethanol); Rhodinol™ (3,7-dimethyloct-6-en-1-ol); Sandalore™ (3-methyl-5-(2,2,3-trimethylcyclopent-3-en-1-yl)pentan-2-01); terpineol (2-(4-methylcyclohex-3-en-1-yl)propan-2-01); or Timberol™ (1-(2,2,6-trimethylcyclohexyl)hexan-3-01); 2,4,7-trimethylocta-2,6-dien-1-ol, [1-methyl-2(5-methylhex-4-en-2-yl)cyclopropyl]-methanol, and/or 2,4,7-trimethyloct-6-en-1-ol;
aldehydes and ketones, e.g. anisaldehyde (4-methoxybenzaldehyde); alpha amyl cinnamic aldehyde (2-benzylideneheptanal); Georgywood™ (1-(1,2,8,8-tetramethyl-1,2,3,4,5,6,7,8-octahydronaphthalen-2-yl)ethanone); Hydroxycitronellal (7-hydroxy-3,7-dimethyloctanal); Iso E Super° (1-(2,3,8,8-tetramethyl-1,2,3,4,5,6,7,8-octahydronaphthalen-2-ypethanone); Isoraldeine° ((E)-3-methyl-4-(2,6,6-trimethylcyclohex-2-en-1-yl)but-3-en-2-one); 3-(4-isobutyl-2-methylphenyl)propanal; maltol; methyl cedryl ketone; methylionone; verbenone; and/or vanillin;
ether and acetals, e.g. Ambrox® (3a,6,6,9a-tetramethyl-2,4,5,5a,7,8,9,9b-octahydro-1H-benzo[e][1]benzofuran); geranyl methyl ether ((2E)-1-methoxy-3,7-dimethylocta-2,6-diene); rose oxide (4-methyl-2-(2-methylprop-1-en-1-yl)tetrahydro-2H-pyran); and/or Spirambrene® (2′,2′,3,7,7-pentamethylspiro[bicyclo[4.1.0]heptane-2,5′-[1,3]dioxane]);
esters and lactones, e.g. benzyl acetate; cedryl acetate ((1S,6R,8aR)-1,4,4,6-tetramethyloctahydro-1H-5,8a-methanoazulen-6-yl acetate); y-decalactone (6-pentyltetrahydro-2 H-pyran-2-one); Helvetolide® (2-(1-(3,3-dimethylcyclohexyl)ethoxy)-2-methylpropyl propionate); rundecalactone (5-heptyloxolan-2-one); and/or vetiveryl acetate ((4,8-dimethyl-2-propan-2-ylidene-3,3a,4,5,6,8a-hexahydro-1H-azulen-6-yl) acetate);
macrocycles, e.g. Ambrettolide ((Z)-oxacycloheptadec-10-en-2-one); ethylene brassylate (1,4-dioxacycloheptadecane-5,17-dione); and/or Exaltolide® (16-oxacyclohexadecan-1-one); and
heterocycles, e.g. isobutylquinoline (2-isobutylquinoline).

Further examples of known fragrance ingredients with which the fragrance mixture may be combined include 6-methoxy-2,6-dimethylheptan-1-al (Methoxymelonal); 5,9-dimethyl-4,8-decadienal (Geraldehyde); octahydro-8,8-dimethylnaphthalene-2-carbaldehyde (Cyclomyral); 5-methyl-2-(1-methylbutyl)-5-propyl-1,3-dioxan (Troenan); 3,7,11-trimethyldodeca-1,6,10-trien-3-ol (optionally as an isomeric mixture) (Nerolidol); 2-methyl-4-phenylbutan-2-ol (dimethylphenylethylcarbinol); 1-(1-hydroxyethyl)-4-(1-methylethyl)cyclohexane (optionally as a mixture of the diastereoisomers) (Mugetanol); (4-methyl-3-pentenyl)cyclohexenecarbaldehyde (Citrusal); 3-(p-(2-methylpropyl)phenyl)-2-methylpropionaldehyde (Silvia!); 3-p-cumenyl-2-methylpropionaldehyde (Cyclamenaldehyde); and mixtures of: cis-tetrahydro-2-isobutyl-4-methylpyran-4-ol and trans-tetrahydro-2-isobutyl-4-methylpyran-4-ol.

Even further examples of known fragrance ingredients may include Amyl Salicylate (pentyl 2-hydroxybenzoate); Aurantiol® ((E)-methyl 2-((7-hydroxy-3,7-dimethyloctylidene)amino)benzoate); Benzyl Salicylate (benzyl 2-hydroxybenzoate); Cis-3-hexenyl Salicylate ((Z)-hex-3-en-1-yl 2-hydroxybenzoate); Citronellyl Oxyacetaldehyde (2-((3,7-dimethyloct-6-en-1-yl)oxy)acetaldehyde); Cyclemax (3-(4-propan-2-ylphenyl)propanal); Cyclohexyl Salicylate (cyclohexyl 2-hydroxybenzoate); Cyclomyral® (8,8-dimethyl-1,2,3,4,5,6,7,8-octahydronaphthalene-2-carbaldehyde); Cyclopentol (2-pentylcyclopentan-1-ol); Cymal (4-(4-hydroxy-4-methylpentyl)cyclohex-3-enecarbaldehyde); Dupical ((E)-4-((3aS,7aS)-hexahydro-1H-4,7-methanoinden-5(6H)-ylidene)butanal); Floral Super ((4E)-4,8-dimethyldeca-4,9-dienal); Florhydral® (3-(3-isopropylphenyl)butanal); Florol® (2-isobutyl-4-methyltetrahydro-2H-pyran-4-131); Gyrane (2-butyl-4,6-dimethyl-3,6-dihydro-2H-pyran); Hexyl Salicylate (hexyl 2-hydroxybenzoate); Helional (3-(1,3-benzodioxo1-5-yl)-2-methylpropanal); Lyral® (4-(4-hydroxy-4-methylpentyl)cyclohex-3-enecarbaldehyde); Majantol® (2,2-dimethyl-3-(m-tolyl)propan-1-ol); Mayol® ((4-isopropylcyclohexyl)-methanol); Melafleur (8,8-dimethyl-2,3,4,5,6,7-hexahydro-1H-naphthalene-2-carbaldehyde); Melonal (2,6-dimethylhept-5-enal); Muguesia (3-methyl-4-phenylbutan-2-ol); Muguet alcohol (3-cyclohexyl-2,2-dimethylpropan-1-ol); Verdantiol ((E)-methyl 2-((3-(4-(tert-butyl)phenyl)-2-methylprop-1-en-1-yl)amino)benzoate); Peonile (2-cyclohexylidene-2-phenylacetonitrile); Phenoxanol° (3-methyl-5-phenylpentan-1-01); Rossitol° (3-isobutyl-1-methylcyclohexanol); Suzaral (2-methyl-3-[4-(2-methylpropyl)phenyl]propanal); Muguol° (3,7-dimethylocta-4,6-dien-3-ol); Tetrahydro Linalool (3,7-dimethyloctan-3-ol); Acalea ((2E)-2-[(4-methylphenyl)methylidene]-heptanal); Dihydro IsoJasmonate (methyl 2-hexyl-3-oxocyclopentane-1-carboxylate); Hexyl Cinnamic Aldehyde ((E)-2-benzylideneoctanal); Acetoin (3-hydroxybutan-2-one); Adoxal (2,6,10-trimethylundec-9-enal); Aldolone® (7-propyl-2H-1,5-benzodioxepin-3(4H)-one); Ambrocenide° ((4aR,5R,7aS,9R)-Octahydro-2,2,5,8,8,9a-hexamethyl-4H-4a,9-methanoazuleno[5,6-d]-1,3-dioxole); Ambroxan (3a,6,6,9a-tetramethyl-2,4,5,5a,7,8,9,9b-octahydro-1H-benzo[e][1]benzofuran); Bacdanol° ((E)-2-ethyl-4-(2,2,3-trimethylcyclopent-3-en-1-yl)but-2-en-1-01); Calone 1951° (7-methyl-2H-benzo[b][1,4]dioxepin-3(4H)-one); Cetalox° (3a,6,6,9a-tetramethyl-2,4,5,5a,7,8,9,9b-octahydro-1H-benzo[e] [1]benzofuran); Cinnamic alcohol ((E)-3-phenylprop-2-en-1-ol); Cyclabute ((3aR,6S,7aS)-3a,4,5,6,7,7a-hexahydro-1H-4,7-methanoinden-6-ylisobutyrate); Cyclacet™ ((3aR,6S,7aS)-3a,4,5,6,7,7a-hexahydro-1H-4,7-methanoinden-6-yl acetate); Cyclaprop ((3aR,6S,7aS)-3a,4,5,6,7,7a-hexahydro-1H-4,7-methanoinden-6-yl propionate); Cyclohexadecanolide; Cyclohexadecenone; Cyclopentadecanone; Delta Damascone ((E)-1-(2,6,6-trimethylcyclohex-3-en-1-yl)but-2-en-1-one); Elintaal Forte (3-(1-ethoxyethoxy)-3,7-dimethylocta-1,6-diene); Ethyl Vanillin (3-ethoxy-4-hydroxybenzaldehyde); Exaltenone ((4Z)-cyclopentadec-4-en-1-one); Floralozone (3-(4-ethylphenyl)-2,2-dimethylpropanal); Fructalate (diethyl cyclohexane-1,4-dicarboxylate); Habanolide ((E)-oxacyclohexadec-12-en-2-one); Galaxolide (4,6,6,7,8,8-hexamethyl-1,3,4,6,7,8-hexahydro-cyclopenta[g]isochromene); Hydroxyambran° (2-cyclododecylpropan-1-01); Jasmal (3-pentyltetrahydro-2H-pyran-4-yl acetate); Javanol° ((1-methyl-2-((1,2,2-trimethylbicyclo[3.1.0]hexan-3-yl)methyl)cyclopropyl)methanol); Lauric Aldehyde (Dodecanal); Mefranal (3-methyl-5-phenylpentanal); Muscenone ((Z)-3-methylcyclopentadec-5-enone); Tonalid° (1-(3,5,5,6,8,8-hexamethyl-5,6,7,8-tetrahydronaphthalen-2-yl)ethanone); Nectaryl° (2-(2-(4-methylcyclohex-3-en-1-yl)propyl)cyclopentanone); Norlimbanol (1-(2,2,6-trimethylcyclohexyphexan-3-131); Raspberry ketone (4-(4-hydroxyphenyl)butan-2-one); Pinoacetaldehyde (3-(6,6-dimethylbicyclo[3.1.1]hept-2-en-2-yl)propanal); Romandolide® (acetic acid (1-oxopropoxy)-, 1-(3,3-dimethyl cyclohexyl)ethyl ester); Sanjinol ((E)-2-ethyl-4-(2,2,3-trimethylcyclopent-3-en-1-yl)but-2-en-1-01); and/or Velvione® ((Z)-cyclohexadec-5-enone).

The perfume composition need not be limited to the odorant ingredients listed above.

Other odorant ingredients commonly used in perfumery may be employed, for example any of those ingredients described in “Perfume and Flavour Chemicals”, S. Arctander, Allured Publishing Corporation, 1994, IL, USA, which is incorporated herein by reference, including essential oils, plant extracts, absolutes, resinoids, odourants obtained from natural products and the like. Preferably, care should be taken that only ingredients are used at concentrations which are regarded as non-sensitizing.

The term “auxiliary agent” refers to ingredients that might be employed in a perfume composition for reasons not specifically related to the olfactive performance of said composition. For example, an auxiliary agent may be an ingredient that acts as an aid to processing an odorant ingredient or ingredient(s), or a composition containing said ingredient(s), or it may improve handling or storage of an odorant ingredient or composition containing same. It might also be an ingredient that provides additional benefits such as imparting color or texture. It might also be an ingredient that imparts light resistance or chemical stability to one or more ingredients contained in a fragrance composition. A detailed description of the nature and type of adjuvants commonly used in fragrance compositions containing same cannot be exhaustive, but it has to be mentioned that said ingredients are well known to a person skilled in the art.

For example, the perfume composition may optionally comprise an anti-oxidant adjuvant. Said anti-oxidant may be selected from Tinogard® TT (BASF), Tinogard® Q (BASF), Tocopherol (including its isomers, CAS 59-02-9; 364-49-8; 18920-62-2; 121854-78-2), 2,6-bis(1,1-dimethylethyl)-4-methylphenol (BHT, CAS 128-37-0) and related phenols, hydroquinones (CAS 121-31-9).

As a further example of auxiliary agents commonly used in perfume compositions one may mention, e.g., diluents conventionally used in conjunction with odorants, such as diethyl phthalate (DEP), dipropylene glycol (DPG), isopropyl myristate (IPM), triethyl citrate (TEC) and alcohol (e.g. ethanol).

The perfume composition as defined hereinabove may be used in a broad range of fragranced products, e.g. in any field of fine and functional perfumery, that is, products applied to animate or inanimate surfaces in which the provision of a desirable odour to the surface is a primary or secondary purpose. Non-limiting examples of such products include perfumes, air care products, household products, laundry products, body care products and cosmetics. The perfume composition can be employed in widely varying amounts, depending upon the specific product and on the nature and quantity of fragrance ingredients. The proportion is typically from 0.01 to 100 (including, e.g., 0.05, 0.1, 1, 10, 15, 20, 25, 30) weight percent of the product. Such perfume composition(s) and fragranced product(s) do not include any product intended for human or animal ingestion, for example, foodstuffs and medicines. In one embodiment, the perfume composition of the present invention may be employed in fragranced products like a fabric softener in an amount of from 0.01 to 1 weight percent, e.g. 0.3, 0.8 weigh percent. However, these values are given only by way of example, since the experienced perfumer may also achieve effects with lower or higher concentrations.

For a fragranced product to be regarded as “essentially free of Citral” means that the fragranced product comprises Citral at a concentration which is far below the sensitizing level of Citral. Preferably, the concentration of Citral should be 10 ppm (0.001 wt %) or less in the final product if the product is to be applied to and left on the human skin (so called leave-on products, such as body creams, deodorants or fine perfumery) and below 100 ppm (0.01 wt %) if the product is to be applied to the human skin which is subsequently rinsed (so called rinse-off products, such as shampoos and shower gels). A Citral content below these levels is considered to be far below the sensitizing levels. As will be understood from the amount of perfume composition to be added to a fragranced product, the amount of Citral which may be acceptable in a perfume composition is from 0.01 wt % (e.g. for perfume composition applied to fine perfumery) to 1 wt % (e.g. perfume composition @ 0.1 wt % for a personal care product such as body lotion or body cream).

Accordingly, a perfume composition “essentially free of citral” means a composition preferably comprising 1 wt % or less (e.g. 0.5 wt % or less, such as 0.1 wt % or less, 0.05 wt % or less of Citral) based on the perfume composition.

The perfume composition as defined hereinabove may be employed in a consumer product base simply by directly mixing the perfume composition as defined hereinabove with the consumer product base, or it may, in an earlier step, be entrapped with an entrapment material, for example, polymers, capsules, microcapsules and nanocapsules, liposomes, film formers, absorbents such as carbon or zeolites, cyclic oligosaccharides and mixtures thereof, and then mixed with the consumer product base.

Thus, there is provided in a further aspect a method of manufacturing a fragranced product, comprising the incorporation of a perfume composition as defined hereinabove by admixing the perfume composition to the consumer product base, using conventional techniques and methods.

The invention also provides a fragranced product comprising:
a) the perfume composition as defined above; and
b) a consumer product base.

In a further aspect there is provided a fragranced product comprising
a) the perfume composition as defined above; and
b) a consumer product base;

wherein the fragranced product comprises 100 ppm (0.01 wt %) or less Citral.

As used herein, ‘consumer product base’ means a composition for use as a consumer product to fulfil specific actions, such as cleaning, softening, and caring or the like. Examples of such products include fine perfumery, e.g. perfume and eau de toilette; fabric care, household products and personal care products such as laundry care detergents, rinse conditioner, personal cleansing composition, detergent for dishwasher, surface cleaner; laundry products, e.g. softener, bleach, detergent; body-care products, e.g. shampoo, shower gel; air care products and cosmetics, e.g. deodorant, vanishing crème. This list of products is given by way of illustration, and is not to be regarded as being in any way limiting.

The invention is now further described with reference to the following non-limiting examples. These examples are for the purpose of illustration only, and it is understood that variations and modifications can be made by one skilled in the art.

The perfume compositions of the Examples 5-7 have been smelled at 5 weight % in an alcoholic solution (alcohol)85°.

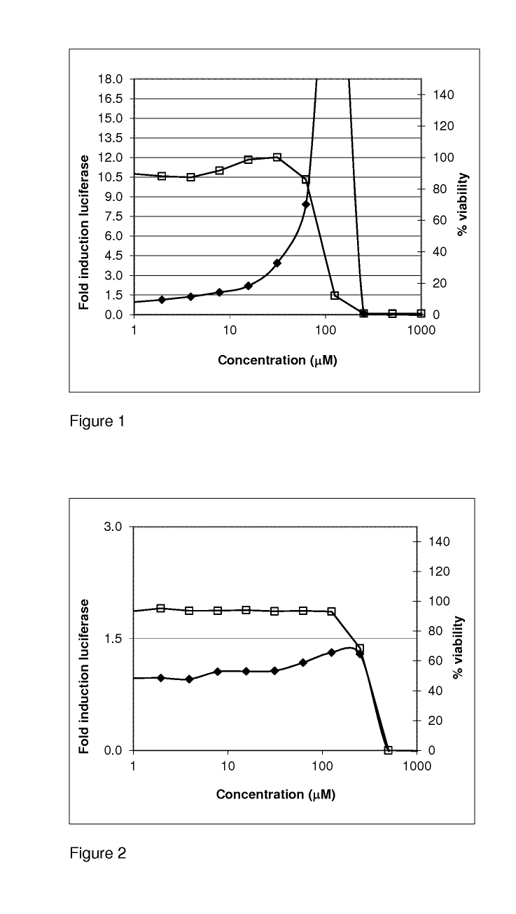

FIG. 1: shows the gene-induction and cell viability curves for Citral in the KeratinoSens® assay, in which the black diamonds indicate the induction of the luciferase activity and the open squares cellular viability.

FIG. 2: shows gene-induction and cell viability curves for 2,4,7-trimethyl-2,6,-octadienal in the KeratinoSens® assay, in which the black diamonds indicate the induction of the luciferase activity and the open squares cellular viability.

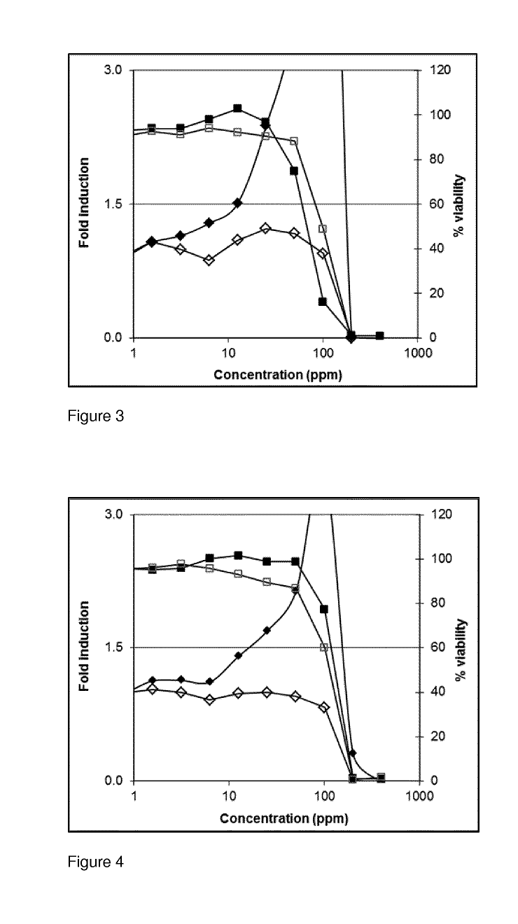

FIG. 3: shows the gene-induction and cell viability curves for composition (a) (comparison) and (b) of Table 3. The filled black diamonds indicate the induction of the luciferase activity for the composition (a) containing Citral and the open diamonds show gene induction for the composition (b) containing 2,4,7-trimethyl-2,6,-octadienal instead of Citral. Filled black squares indicate cellular viability for the formulations with Citral and open squares indicate cellular viability for composition containing 2,4,7-trimethyl-2,6,-octadienal, respectively.

FIG. 4: shows the gene-induction and cell viability curves for composition (c) (comparison) and (d). The filled black diamonds indicate the induction of the luciferase activity for the composition (c) containing Citral and the open diamonds show gene induction for the composition (d) containing 2,4,7-trimethyl-2,6,-octadienal instead of Citral. Filled black squares indicate cellular viability for the formulations with Citral and open squares indicate cellular viability for composition containing 2,4,7-trimethyl-2,6,-octadienal, respectively.

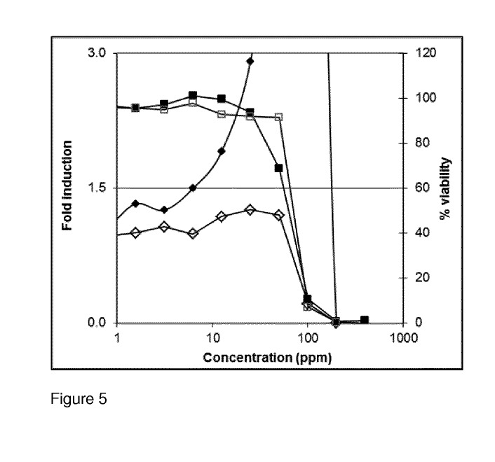

FIG. 5: shows the gene-induction and cell viability curves for composition (e) (comparison) and (f). The filled black diamonds indicate the induction of the luciferase activity for the composition (e) containing Citral and the open diamonds show gene induction for the composition (f) containing 2,4,7-trimethyl-2,6,-octadienal instead of Citral. Filled black squares indicate cellular viability for the formulations with Citral and open squares indicate cellular viability for composition containing 2,4,7-trimethyl-2,6,-octadienal, respectively.

### EXAMPLE 1

### Skin Sensitization Test of 2,4,7-trimethyl-2,6,-octadienal in Comparison with Citral in a Cell-Based Assay

Compounds were tested using the commercial KeratinoSens® assay for skin sensitization. The KeratinoSens® test compares the potential skin sensitization risk of chemicals. The KeratinoSens® cell line contains a stable insertion of a Luciferase gene under the control of the ARE-element of the gene AKR1C2 and induction of luciferase is indicative of skin sensitization potential (R. Emter, G. Ellis, A. Natsch, Toxicol. Appl. Pharmacol. 2010, 245, 281-290). The assay was performed as described by the OECD test guideline 442d. KeratinoSens® cells were grown for 24 h in 96-well plates. The medium was then replaced with medium containing the test chemical and the solvent dimethylsulfoxide (DMSO) at a final level of 1% (v/v). Each compound was tested at 12 binary dilutions in the range from 0.98 to 2000 μM. Cells were incubated for 48 h with the test agents, and then luciferase activity and cytotoxicity were determined. This full procedure was repeated three times for each chemical. For each chemical in each repetition and at each concentration, the gene induction compared to DMSO controls and the wells with statistically significant induction over the threshold of 1.5 (i.e. 50% enhanced gene activity) were determined. Furthermore, the maximal fold-induction (Iₘₐₓ) and the EC1.5 value (concentration in μM for induction above the threshold) were calculated. Chemicals are rated as positive (i.e. likely skin-sensitizers) in the assay if the following three criteria are fulfilled:
(i) EC1.5 value is below 1000 μM.
(ii) At the lowest concentration with a gene induction above 1.5 fold, the cellular viability is above 70%.
(iii) There is an apparent overall dose-response for luciferase induction, which is similar between the repetitions.

2,4,7-trimethyl-2,6,-octadienal was compared with Citral (3,7-dimethyl-2,6-octadienal). The results can be found in Table 1 below, and FIGS. 1 and 2.

TABLE 1
Results of KeratinoSens ®

| | I | II |
|---|---|---|
| Iₘₐₓ (fold maximal gene induction) | 22.3 | 1.40 |
| Concentration for 1.5-fold gene induction (EC 1.5 | 7.7 | n.i. |
| in μM) | | |
| Concentration for 50% Cytotoxicity (in μM) | 95.5 | 317.8 |

n.i. = no induction above threshold of 1.5, indicating negative rating in the assay
I = Citral (3,7-dimethyl-2,6-octadienal)
II = 2,4,7-trimethyl-2,6,-octadienal

Citral is highly active (induces the luciferase gene at about 7.7 μM) whereas 2,4,7-trimethyl-2,6,-octadienal is clearly negative with no induction above the threshold of 1.5 fold and is thus rated as non-sensitizing by this assay.

Accordingly 2,4,7-trimethyl-2,6,-octadienal can be used, e.g. in perfume compositions, for reduced sensitization risk to the consumer.

### EXAMPLE 2

### Skin Sensitization Test 2,4,7-trimethyl-2,6,-octadienal in Comparison with Citral (3,7-dimethyl-2,6-octadienal) in a Peptide Reactivity Assay

Another method to determine allergenic potential of chemicals is the Direct Peptide Reactivity Assay (DPRA; OECD TG 442c). It is based on the fact that allergenic chemicals must react with a peptide/protein in order to be immunogenic.

A modification of the peptide reactivity assay (A. Natsch, H. Gfeller, Toxicol. Sci. 2008, 106, 464-478) was conducted similarly to the DPRA, but including an LC-MS based detection of peptide adducts: The test chemicals were dissolved to a final concentration of 4 mM in acetonitrile and 250 μl of this solution were added to 2 ml HPLC vials. The test peptide Cor1C-420 with the sequence Ac-NKKCDLF (Genscript Inc., Piscataway, N.J., USA), was dissolved at 0.133 mM in 20 mM phosphate buffer at pH 7.5, and 750 μl of this solution were added to each test vial (final concentrations: 1 mM of test chemical and 0.1 mM of peptide; ratio 1:10 as in the DPRA). The samples were incubated for 24 h at 37° C. and analysed by LC-MS analysis on a VELOS PRO Mass spectrometer (Thermo SCIENTIFIC, San Jose, Calif., U.S.A.) operated in the ESI(+) mode.

Mass spectra were recorded from 200-2000 amu. A ZORBAX Eclipse XDB-C18 column, 2.1 mm ID, 150 mm, 5-Micron (Agilent Technologies) was used. The mobile phase consisted of H₂O (A) and methanol (B) each containing 0.1% formic acid (v/v). The solvent flow was 250 μl/min and the following gradient (ratio A:B) was used: 0 min, 95:5; 2 min, 40:60; 10 min, 2:98; 12 min, 2:98. The integration was performed with Xcalibur Quan Browser™.

In order to detect formation of modified peptides, the specific ion trace for a new adduct with the mass of the test chemical added to the test peptide is extracted, and the peak of the peptide-adduct is integrated. Peptide adduct formation is a particular sensitive endpoint to determine reactive, and thus allergenic nature of compounds.

As can be observed in Table 2, modified peptides were observed with both Citral (I) and 2,4,7-trimethyl-2,6,-octadienal (II). However, only traces were formed in the case of 2,4,7-trimethyl-2,6,-octadienal, and this amount is 27-fold lower as compared to Citral, indicating a strongly reduced reactivity and hence sensitization potential for 2,4,7-trimethyl-2,6,-octadienal.

TABLE 2
Result of a peptide reactivity assay

| | I | II |
|---|---|---|
| Expected mass of a | 908.5 + 152.1 = | 908.5 + 166.1 = |
| possible peptide adduct | 1060.6 | 1074.6 |
| Observed mass of | 1060.6 | 1074.6 |
| peptide adduct | | |
| Peptide reactivity: | Direct Michael | Extremely low activity, |
| quantification | adduct observed, | traces of direct adduct |
| | 8.1% of parent | observed, 0.3% of parent |
| | peptide modified | peptide modified |

### EXAMPLE 3

### Skin Sensitization Test of Compositions Containing 2,4,7-trimethyl-2,6,-octadienal in Comparison to Compositions Containing Citral in a Cell-Based Assay

Perfume compositions containing 2,4,7-trimethyl-2,6,-octadienal or Citral and, in addition, materials selected from group A or from group A and B were formulated according to Table 3 (in parts by weight). These compositions were tested in the cell-based KeratinoSens® assay as described in Example 1. All compositions were tested in the concentration range from 0.2-400 ppm (parts per million in weights per volume).

TABLE 3
Perfumery compositions

| Perfumery raw materials | | composition | | | | | |
|---|---|---|---|---|---|---|---|
| | Group | (a) | (b) | (c) | (d) | (e) | (f) |
| dihydro myrcenol | (A) | 30 | 30 | 30 | 30 | 20 | 20 |
| Hedione | (A) | 30 | 30 | 30 | 30 | 20 | 20 |
| Ethyllinalool | (A) | 20 | 20 | 30 | 30 | 20 | 20 |
| Methyl- | (A) | | | | | 5 | 5 |
| pamplemousse | | | | | | | |
| Citronellyl nitrile | (B) | | | | | 5 | 5 |
| Rhubafuran | (B) | | | | | 10 | 10 |
| Citral | | 20 | | 10 | | 20 | |
| 2,4,7-trimethyl-2,6,- | | | 20 | | 10 | | 20 |
| octadienal | | | | | | | |
| Total | | 100 | 100 | 100 | 100 | 100 | 100 |

The results can be found in Table 4 below and FIGS. 3 to 5.

TABLE 4
KeratinoSens ® result for perfume compositions (a) to (f)

| | (a) | (b) | (c) | (d) | (e) | (f) |
|---|---|---|---|---|---|---|
| Iₘₐₓ (fold | 9.43 | 1.35 | 3.50 | 1.13 | 11.49 | 1.26 |
| maximal gene | | | | | | |
| induction) | | | | | | |
| Concentration | 60.5 | n.i. | 83.3 | n.i. | 32.0 | n.i. |
| for 1.5-fold | | | | | | |
| gene induction | | | | | | |
| (EC 1.5 in | | | | | | |
| ppm) | | | | | | |
| Concentration | 355.3 | 512.2 | 678.2 | 556.4 | 312.4 | 372.5 |
| for 50% | | | | | | |
| Cytotoxicity | | | | | | |
| (in ppm) | | | | | | |

n.i. = no induction above threshold of 1.5, indicating negative rating in the assay
(a)-(f) = Perfume compositions according to Table 3

Formulations containing 10-20 wt % of citral are highly active (they induce the luciferase gene at about 32-83 ppm) whereas 2,4,7-trimethyl-2,6,-octadienal containing formulations are clearly negative with no induction above the threshold of 1.5 —fold and thus are rated as non-sensitizing formulations by this assay.

Accordingly, formulations with a citrus note containing 2,4,7-trimethyl-2,6,-octadienal and materials selected from group (A) and, optionally, group (B) can be used, e.g. in perfume compositions or consumer products, for reduced sensitization risk to the consumer.

### EXAMPLE 4

### Skin Sensitization Test of 2,4,7-trimethyl-2,6,-octadienal in Comparison with Citral by TIMES SS Model

The TIMES SS model is a computer model which predicts the sensitization potential based on all known structural features of skin sensitizers. This model was trained by all available expert knowledge on structural alerts over the years (Roberts, D. W., G. Patlewicz, et al. (2007). Chemical Research in Toxicology 20(9): 1321-1330). Recent improvements were described by Patlewicz, G., C. Kuseva, et al. (2014). SAR QSAR Environ Res 25(5): 367-391). The most updated model available is Version 20.24 obtained from OASIS, LMC.

2,4,7-Trimethyl-2,6,-octadienal and Citral were run through the TIMES SS model (version 20.24). The results are given in Table 5 below.

TABLE 5
Result from TIMES SS

| | | 2,4,7-trimethyl- |
|---|---|---|
| TIMES parameter | Citral | 2,6,-octadienal |
| Predicted SkinSens | Strong sensitizer | Strong sensitizer |
| Transformation | Schiff base formation | Michael type addition |
| | with disubstituted | on α,β-aldehydes |
| | α,β-aldehydes | |
| Active alert | Di-substituted α,β- | α,β-Aldehydes |
| | unsaturated aldehydes | |
| Alert performance | High, >=60% (n >= 5) | High, >=60% (n >= 5) |
| Amount Adduct/mol | 0.3666 | 0.472 |

As can be seen from the results above (Table 5), both chemicals are predicted as strong skin sensitizers. For 2,4,7-trimethyl-2,6,-octadienal an even higher protein binding (Amount adduct/mol) is predicted. Accordingly, the in silico model indicates that based on the current general understanding of structural alerts for skin sensitization, 2,4,7-trimethyl-2,6,-octadienal would be expected to be an equally strong or stronger skin sensitizer as compared to Citral.

### EXAMPLE 5

### Musk Perfume Composition for Fine Perfumery

| | 5(a) | 5(b) |
|---|---|---|
| geranyl acetate | 10 | 10 |
| 2-phenylethan-1-ol | 60 | 60 |
| Ambermax¹⁾ @ 10 wt % in TEC | 50 | 50 |
| Ambrofix²⁾ | 10 | 10 |
| ethylene brassylate | 250 | 250 |
| Damascenone giv | 2 | 2 |
| Galaxolide | 238 | 238 |
| Givescone³⁾ | 30 | 30 |
| Hedione (group (A) compound) | 130 | 130 |
| Javanol | 3 | 3 |
| Mefrosol⁴⁾ | 50 | 50 |
| Rose oxide @ 10 wt % in DEP | 2 | 2 |
| Thibetolide⁵⁾ | 150 | 150 |
| Citral | 15 | — |
| 2,4,7-trimethyl-2,6,-octadienal | — | 15 |
| Total | 1000 | 1000 |

¹⁾mixture of 2-(1,1,5,5-tetramethyl-1,3,4,5,6,8a-hexahydro-2H-2,4a-methanonaphthalen-8-yl)propan-1-ol and 2-(1,1,5,5-tetramethyl-1,3,4,5,6,7-hexahydro-2H-2,4a-methanonaphthalen-8-yl)propan-1-ol
²⁾dodecahydro-3a,6,6,9a-tetramethylnaphtho[2,1-b]furan
³⁾ethyl 2-ethyl-6,6-dimethylcyclohex-2-ene-1-carboxylate
⁴⁾3-methyl-5-phenyl-1-pentanol
⁵⁾oxacyclohexadecan-2-one

In formula 5(a), 1.5 wt % Citral supports the freshness and performance of the accord, reinforcing the natural impression.

In formula 5(b), Citral was replaced by 2,4,7-trimethyl-2,6,-octadienal, which brings a very similar natural impression, and supports also both the freshness and performance.

### EXAMPLE 6

### Spicy-Citrus Perfume Composition

| | 6(a) | 6(b) |
|---|---|---|
| citronellyl acetate | 80 | 80 |
| decanal | 3 | 3 |
| Borneol (crystals) | 1 | 1 |
| lemon terpenes (citral free) | 230 | 230 |
| (E)-dec-4-enal | 1 | 1 |
| Elemi Oil | 30 | 30 |
| Ethyl Linalol (group (A) compound) | 140 | 140 |
| Eucalyptol (natural) | 20 | 20 |
| Mefrosol | 120 | 120 |
| Hedione (group (A) compound) | 310 | 310 |
| dihydroeugenol | 5 | 5 |
| Methyl Pamplemousse (group (A) comp.) | 44 | 44 |
| Vanillin @ 10 wt % in TEC | 1 | 1 |
| Citral | 15 | — |
| 2,4,7-trimethyl-2,6,-octadienal | — | 15 |
| Total | 1000 | 1000 |

In the formula 6(a), 1.5 wt % Citral supports the freshness and performance of the accord, reinforcing the natural impression.

In formula 6(b), Citral was replaced by 2,4,7-trimethyl-2,6,-octadienal, which brings a similar natural impression, and supports also both the freshness and performance

### EXAMPLE 7

### Rose Musk Perfume Composition

| | 7(a) | 7(b) |
|---|---|---|
| geranyl acetate | 240 | 240 |
| hexenyl-3-cis acetate @ 10 wt % in TEC | 2 | 2 |
| prenyl acetate | 1 | 1 |
| 2-phenylethan-1-ol | 210 | 210 |
| decanal @10 wt % in TEC | 3 | 3 |
| dihydro myrcenol (group (A) compound) | 50 | 50 |
| Delta Damascone | 2 | 2 |
| dihydroeugenol | 3 | 3 |
| Galaxolide | 130 | 130 |
| Mefrosol | 240 | 240 |
| (Z)-hex-3-en-1-ol | 1 | 1 |
| Isoraldeine | 40 | 40 |
| 3-(4-isobutyl-2-methylphenyl)propanal | 30 | 30 |
| (group (B) compound) | | |
| Rose Oxide @10 wt % in DPG | 3 | 3 |
| Hexenyl-3-Cis Salicylate¹⁾ | 30 | 30 |
| Citral | 15 | — |
| 2,4,7-trimethyl-2,6,-octadienal | — | 15 |
| Total | 1000 | 1000 |

¹⁾(Z)-hex-1-en-1-yl 2-hydroxy-3-methylbenzoate

In formula 7(a), 1.5 wt % citral supports the freshness and performance of the accord, reinforcing the natural impression.

In formula 7(b), Citral was replaced by 2,4,7-trimethyl-2,6,-octadienal, which supports the freshness and performance of the fragrance, and brought a slightly sweeter citrus character, more like a juicy lemon, but still fitting in the general character and original overall impression.

1. A perfume composition comprising 2,4,7-trimethyl-2,6-octadienal, characterized in that the perfume composition is essentially free of 3.7-dimethyl-2,6-octadienal.

2. The perfume composition according to claim 1, wherein the perfume composition comprises
I) 2,4,7-trimethyl-2,6-octadienal; and
II) at least one compound selected from the group (A) consisting of 2,6-dimethyloct-7-en-2-ol, 6,6-dimethoxy-2,5,5-trimethylhex-2-ene, methyl 3-oxo-2-pentylcyclopentaneacetate, (E)-3,7-dimethylnona-1,6-dien-3-ol, 3-(4-isobutyl-2-methylphenyl)propanal, 2,4,7-trimethyloct-6-en-1-ol, and mixtures thereof; and
III) optionally at least one compound selected from the group (B) consisting of 3,7-dimethylnona-2,6-dienenitrile, 3,7-dimethyloct-6-enenitrile, 3,7-dimethyl-6-octen-1-ol, 2,4-dimethyl-4-phenyltetrahydrofuran, 1-methyl-4-(4-methyl-3-pentenyl)-3-cyclohexene-1-carbaldehyde, and mixtures thereof.

3. The perfume composition according to claim 2 wherein the weight ratio of 2,4,7-trimethyl-2,6-octadienal to the total amount of group (A) compounds is at least 1:3.

4. A fragranced product comprising the perfume composition according to claim 1.

5. The fragranced product according to claim 4, wherein the product is intended to be applied to the skin.

6. A perfume composition essentially free of 3,7-dimethyl-2,6-octadienal, comprising 2,4,7-trimethyl-2,6-octadienal, characterized in that said perfume composition has a reduced sensitizing potential compared with an identical perfume composition in which 2,4,7-trimethyl-2,6-octadienal has been replaced by an equal weight of 3,7-dimethyl-2,6-octadienal.

7. A method of substituting 3,7-dimethyl-2,6-octadienal in a perfume composition comprising the step of admixing to a perfume composition, which is essentially free of 3,7-dimethyl-2,6-octadienal,
I) 2,4,7-trimethyl-2,6-octadienal; and
II) at least one compound selected from the group (A) consisting of 2,6-dimethyloct-7-en-2-ol, 6,6-dimethoxy-2,5,5-trimethylhex-2-ene, methyl 3-oxo-2-pentylcyclopentaneacetate, (E)-3,7-dimethylnona-1,6-dien-3-ol, 3-(4-isobutyl-2-methylphenyl)propanal, 2,4,7-trimethyloct-6-en-1-ol, and mixtures thereof; and
III)optionally at least one compound selected from the group (B) consisting of 3,7-dimethylnona-2,6-dienenitrile, 3,7-dimethyloct-6-enenitrile, 3,7-dimethyl-6-octen-1-ol, 2,4-dimethyl-4-phenyltetrahydrofuran, 1-methyl-4-(4-methyl-3-pentenyl)-3-cyclohexene-1-carbaldehyde, and mixtures thereof.

8. A method of providing a perfume composition with reduced skin sensitization potential by providing a perfume composition which is essentially free of 3,7-dimethyl-2,6-octadienal, and wherein the perfume composition comprises 2,4,7-trimethyl-2,6,-octadienal.

9. A method of producing a fresh, natural, juicy odor characteristic to a perfume composition comprising the step of adding to said perfume composition 2,4,7-trimethyl-2,6,-octadienal.

10. The method according to claim 9 characterized in that the perfume composition is essentially free of 3,7-dimethyl-2,6-octadienal.

11. (canceled)

12. A fragranced product comprising the perfume composition according to claim 2.

13. A fragranced product comprising the perfume composition according to claim 3.

14. A method of imparting freshness and naturalness to a fragranced product, said method comprising the step of incorporating into said product a perfume composition comprising 2,4,7-trimethyl-2,6,-octadienal, and at least one compound selected from group (A) consisting of 2,6-dimethyloct-7-en-2-ol, 6,6-dimethoxy-2,5,5-trimethylhex-2-ene, methyl 3-oxo-2-pentylcyclopentaneacetate, (E)-3,7-dimethylnona-1,6-dien-3-ol, 3-(4-isobutyl-2-methylphenyl)propanal, and 2,4,7-trimethyloct-6-en-1-ol.

15. The method according to claim 14 wherein the weight ratio of 2,4,7-trimethyl-2,6-octadienal to the total amount of group (A) compounds is 1:3 to 1:50.
